(19) United States
(12) Patent Application Publication
(10) Pub. No.: US 2015/0014296 A1
(43) Pub. Date: Jan. 15, 2015

(54) HEAT GENERATING DEVICE USING ARC DISCHARGE REACTOR, SOLAR LIGHT COLOR ARC GENERATING DEVICE, AND HIGH-PRESSURE DISCHARGE LAMP

(71) Applicants: Kisung Kim, Gyeonggido (KR); Hee Jae Kim, Gyeonggido (KR)

(72) Inventors: Kisung Kim, Gyeonggido (KR); Hee Jae Kim, Gyeonggido (KR)

(73) Assignee: Gear Technology Co., Ltd., Gyounggi-do (KR)

(21) Appl. No.: 14/374,553

(22) PCT Filed: Oct. 8, 2012
(86) PCT No.: PCT/KR2012/008133

§ 371 Date: Jul. 25, 2014

(30) Foreign Application Priority Data
Jan. 27, 2012 (KR) 10-2012-0008384

(51) Int. Cl. H05B 7/18; H01J 65/04; F22B 1/30

(52) U.S. Cl. CPC H05B 7/18; F22B 1/30; H01J 65/048
USPC 219/383; 315/344; 315/200 R

(57) ABSTRACT

The present invention relates to a heat generating device using an arc discharge reactor. One object of the present invention is to not only discharge a high brightness arc but also to make an arc which discharges at an even higher brightness when a magnet is placed nearby. The heat generating device using the arc discharge reactor according to the present invention comprises: a voltage regulator (1100) receiving an external power supply to reliably supply voltage; a transformer (1200) of which the primary side is electrically connected to the voltage regulator (1100) and the secondary side is connected to a rectifier (1210); an arc reactor 1410 at which a pair of second and first terminal portions (1311, 1321) are disposed at a predetermined interval to enable plasma flow; a first reactor (1400) of which one end is connected to both poles of the rectifier (1210) and the other end is connected to the first terminal portion (1321) so as to generate an arc discharge having magnetic properties; and a series field portion (1500) disposed on both sides of the arc reactor 1410 so as to form a magnetic field vertically with respect to the moving direction of the plasma, wherein both ends of the series field portion are respectively electrically connected to the negative pole of the rectifier (1210) and the first terminal portion (1311).

### TECHNICAL FIELD

The present invention relates, in general, to a high-temperature heat generation device using a reactor, an arc generation device, and a high-pressure discharge lamp and, more particularly, to a high-temperature heat generation device using a reactor which causes arc discharge having magnetism, and a sunlight color arc generation device and high-pressure discharge lamp, which uniformly generate light over the entire frequency band of visible light and suppress light such as X rays harmful to human bodies.

### BACKGROUND ART

A typical reactor is installed in an arc discharge lamp and implemented using a magnetic leakage iron core so as to prevent large tube current from flowing through the discharge lamp, but is problematic in that a large amount of magnetic flux is leaked due to the inherent properties of a magnetic field.

As a reactor for causing arc discharge having magnetism, a device which supplies a spiral current to ionic water, generates vapor, and uses the vapor as a power source is disclosed, and, for the device, Korean Patent Application No. 10-2009-61083 (entitled “Nuclear fusion reactor and boiler system using the same”) which is based on a claim for priority of Korean Patent Application No. 10-2008-69957 was filed.

However, in the patent, the core of the invention is not desirably disclosed, and essential components required to exhibit the unique effects of the invention are omitted, and thus a high-temperature heat generation device using a reactor for causing arc discharge having magnetism is required.

Meanwhile, because of rapid industrial revolution, welding has advanced into the form of arc welding, and industrial accidents inevitably occur due to exposure to high frequency (X-rays) of an arc. These types of industrial accidents are related to human bodies, and it is known that there is a strong possibility of welding to cause peritenonitis, bursitis, and epicondylitis occurring in the brachium and forearm. To shield against the high frequencies of an arc, industrial injuries have been reduced by merely installing a protective guard (a defense guard) for welders. That is, a conventional are emits more light in a specific wavelength band and is discontinuous, and the reason for this is given as follows.

An atom is divided into a nucleus, a static electron, and a free electron, wherein the free electron determines most properties of the atom. It is known that when an external electron collides with the atom, the free electron is uniformly ionized from the atom and has constant ionization energy. The constant ionization energy is represented by the following Equation 1:

W₂−W₁=hv Equation 1

(h=6.626×10⁻³⁴ J·s/2π)

Energy, remaining after ionization, is the voltage energy of the external electron, and most voltage energy is converted into resistive heat. The constant ionization energy of the free electron is emitted as light energy while being reduced, wherein wavelength λ=c/v

That is, a constant wavelength and a constant frequency are obtained.

In particular, among atoms, a tungsten rod emits a large number of X-rays.

The wavelength of X-rays ranges from 1.00 to 0.001 nm, and the frequency (v) thereof ranges from 3×10¹⁵ to 3×10²⁰ Hz.

Upon welding, an arc rod must be resistant to high temperature, and thus a tungsten rod (a melting point of 3387° C.) must be used. Then, human bodies are exposed to X-rays and it is medically known that physical injuries, such as peritenonitis, bursitis, and epicondylitis occurring in brachium and forearm, occur as various types of physical diseases.

Furthermore, it is also medically known that a high-pressure discharge lamp such as a mercury discharge lamp is also harmful.

Typical fluorescent lamps inherently have a wavelength band ranging from 250 to 370 nm. However, by applying a fluorescent material to such a fluorescent lamp, light rays in three wavelength bands around 450, 540, and 610 nm are emitted. Further, even if high-pressure discharge is strong, a high-pressure mercury lamp only has its bandwidth slightly broadened in the 250 to 370 nm band, and the wavelength band is still discontinuous.

Further, a metal-halide lamp emits light by the injection of a plurality of materials, but emits light in a specific wavelength band even in this case.

Therefore, researchers who study discharge lamps desire to develop discharge lamps for emitting a continuous spectrum such as that of the sun, but satisfactory discharge lamps approximating sunlight have not yet been developed.

Meanwhile, a tokamak device was devised by Soviet physicists Tamm and Sakharov and the American physicist Spitzer in the early 1950s. The term “tokamak” is a Russian compound word, meaning a toroidal chamber with a magnetic field.

In FIG. 6a, the internal magnetic field of a toroid, that is, a toroidal magnetic field Bt, is in inverse proportion to distance. That is, a magnetic field is weakened in a direction from the inside to the outside of the toroid.

A collection of charged particles in an ionized state, that is, having electric charges, is called plasma. Plasma moving in a tokamak is subjected to a Lorentz force which is a force applied to charges moving in a magnetic field. By the Lorentz force, positive charges are subjected to the force in a direction in which a screw is turned when the screw is turned from a motion direction to the direction of a magnetic field, and negative charges are subjected to the force in the opposite direction. Consequently, plasma is subjected to the force in a direction perpendicular to a toroidal magnetic field and a toroidal plane, and then collides with a wall. In order to prevent plasma from colliding with the wall, the direction of the toroidal magnetic field must be formed in a spiral shape. When rotational displacement is applied to the toroidal magnetic field to form a spiral magnetic field Bs, a magnetic field applying rotational displacement is referred to as a ‘poloidal magnetic field Bp.’ In this way, plasma repeats an up-and-down motion in a predetermined region. Depending on methods of applying such rotational displacement, toroids are classified into several types, for example, a stellarator, a heliotron, a torsatron, a tokamak, etc.

As shown in FIG. 6a, a tokamak forms a strong induced electric field within the tokamak in a circular toroidal direction by causing a pulse current to flow through a primary coil using the principle of a transformer. By such an induced electric field, plasma is detached from a nuclear fusion fuel, and the nuclear fusion fuel rotates in the toroidal direction to form current. When the current flows, a circular magnetic field is generated around the current, and thus a poloidal magnetic field is generated. As shown in the drawing, a spiral magnetic field is generated by the sum of the poloidal magnetic field and the toroidal magnetic field.

Bs(spiral magnetic field)=Bp(poloidal magnetic field; rotational displacement)+Bt(toroidal magnetic field)

By means of the current flowing through the plasma, a magnetic well and a magnetic tomogram, as well as the rotational displacement, are formed, and then plasma is stabilized and heated. A tokamak did not attract great attention in its early stage thereof, but T-3 and TM-3 published in 1968 exhibited remarkable results. Since then, continuous research has been conducted.

Tokamaks are used to cause nuclear fusion by forming plasma at ultra-high temperatures. In order to cause nuclear fusion, ultra-high temperature plasma must be hermetically sealed in a container at a temperature of 100 million° C. and a density of 100 billion plasma jets per 1 cm³ for about 1 second. Due to the instability of ultra-high temperature plasma, continuous research and development has been conducted, and there are, for example, Japanese JT-60U tokamak, the EU's Joint European Torus (JET), German ASDEX-U, U.S. DIII-D, etc. Even in Korea, KAIST-tokamak which is a small-sized tokamak is present in Korea Advanced Institute of Science and Technology (KAIST).

For reference, for better understanding of the principle of a tokamak and the principle of the present invention, the principle of a toroidal magnetic field will be described below. When current flows through an electric wire, a magnetic field is formed around the electric wire, and the electric wire is circularly wound so as to effectively form the magnetic field, wherein a wire that is cylindrically wound is called a solenoid, and a wire that is wound in a doughnut shape (toroidal shape) is called a toroid. In an ideal case, a magnetic field is formed inside the toroid, but there is no magnetic field formed outside the toroid.

That is, in FIG. 6b, when current I flows through a toroid having an electric wire toroidaily wound N times, a magnetic field B inside the toroid is represented by the following equation using the Anpere's law which is a relational formula between a magnetic field and current,

B=μ₀N·I/2πr

where μ₀ denotes a constant called permeability in a free space, which is defined by the following equation:

μ₀=4π10⁻⁷[Wb/A·m]

where Wb (Weber) denotes the unit of a magnetic field called a Weber, A denotes ampere which is the unit of current, and m denotes meter which is the unit of length.

As shown in the above equation, the intensity of a magnetic field inside the toroid is in inverse proportion to distance r from the center. However, in most cases, it is assumed that a magnetic field in the toroid is constant, and there is a precondition that the distance r from the center of the toroid to the internal portion of the toroid must be greater than a toroid radius ‘a’. Further, as r is greater than ‘a’, a magnetic field is not present outside the toroid, and a constant magnetic field is formed inside the toroid. In this case, the direction of the magnetic field is a direction in which a screw is turned when the screw is turned in a current flow direction, and the magnetic field is rotated around the toroid while forming a circle.

A toroid is used as an inductor in circuits and has an inductive reactance. Generally, a toroid has an inductance (unit: henry [H]) higher than that of a solenoid. Typically, in order to increase the inductance, a material having high magnetic permeability is inserted into the center of the toroid. Further, a tokamak is generated by deforming a toroid and is used as a nuclear fusion device.

Meanwhile, a poloidal magnetic field, which is the component of the magnetic field of torus-type hermetically sealed plasma, denotes the component of a magnetic field present in the cross-section of the plasma. For example, in the case of a circular cross-section tokamak, when it is assumed that a plasma current is Iₚ, and a radius is α, the intensity Bp of a poloidal magnetic field is given by Bp=μ₀Ip/(2πα), where μ₀ denotes permeability in vacuum. This is also referred to as a ‘poloidal magnetometer.’

When a summary is again provided, the principle of a tokamak is based on a Lorentz force acting on particles having electricity moving in a magnetic field. Since plasma inside the tokamak is in a state in which an atomic nucleus is separated from electrons, the plasma is in the state of particles having electricity, that is, charged particles. Since charged particles are subjected to a Lorentz force in a direction perpendicular to the velocity of a magnetic field and the particles, the charged particles move along a spiral trajectory, as shown in FIG. 6c.

That is, in the parallel magnetic field of FIG. 6c, plasma is moved, as shown in the left drawing (a) of FIG. 6c in which the motion of a charged particle is viewed from above, and in the right drawing (b) of FIG. 6c in which the motion is viewed from the side. When a doughnut-shaped magnetic field is formed, a charged particle in the magnetic field is confined while rotating in the magnetic field, and this is the basic principle of a tokamak for confining plasma.

However, an actual tokamak needs to control the plasma such that the plasma inside the tokamak is desirably maintained using various types of magnets as well as the magnet used to form a doughnut-shaped magnetic field. A magnet forming the doughnut-shaped magnetic field in the tokamak is called a Toroidal Field (TF) magnet, a magnet for controlling plasma is called a Poloidal Field (PF) magnet, and a magnet for driving plasma current (current generated while plasma itself is moving) is called a Central Solenoid (CS) magnet.

Consequently, in an actual tokamak device, particles having electric charges are confined in the tokamak device while spirally and vertically moving up and down in the tokamak device, as shown in FIG. 6d.

### PRIOR ART DOCUMENTS

### Patent Document

Korean Patent Application No. 1.0-2009-61083 (Korean Patent Application Publication No: 201.0-9408) (entitled “Nuclear fusion reactor and boiler system using the same”)

### DISCLOSURE

### Technical Problem

An object of the present invention is to provide a high-temperature heat generation device, which supplements the disadvantage of a conventional stabilizer or heater and uses an arc discharge reactor, and the high-temperature heat generation device is used even for a heater for generating high-temperature heat, such as the stabilizer of an arc discharge lamp.

As described above, for arc reactors developed to date, research into methods for improving the color of an are has not yet been conducted, and a high-frequency artificial light source for an arc not only deteriorates psychological and physical health conditions, but also causes psychological anxiety and leads to even industrial injury.

Meanwhile, even high-pressure discharge lamps including conventional mercury discharge lamps are known in the medical world to be harmful due to the influence of harmful rays in a specific wavelength band, but measures for dealing with such harmful waves have not been taken.

Another object of the present invention is to develop a sunlight color arc reactor that exploits a toroidal and poloidal wiring method by utilizing the principle of the conventional tokamak device, so that a method for connecting an electric wire having an iron wire in a toroidal direction and a poloidal direction and for magnetizing current is used, and a device is produced using this method, thus proving that, as the results of the test and analysis of arc colors, harmful light in a high frequency band is hardly present and most light generated is light having frequencies in a visible light band.

### Technical Solution

In accordance with a first aspect of the present invention to accomplish the above objects, there is provided a high-temperature heat generation device using an arc discharge reactor, including a voltage controller (1100) supplied with external power and configured to stably supply a voltage; a transformer (1200) electrically connected on a primary side thereof to the voltage controller (1100) and on a secondary side thereof to a rectifier (1210); an arc reactor (1410) configured to enable flow of plasma, and provided with a pair of second and first terminal parts (1311 and 1321) installed to be spaced apart from each other by a predetermined interval; a first reactor (1400) connected at a first end thereof to an anode of the rectifier (1210) and at a second end thereof to the first terminal part (1321), and configured to cause arc discharge having magnetism; and a series field part (1500) arranged on opposite sides with respect to the arc reactor (1410) so that a magnetic field is formed in a direction perpendicular to a movement direction of plasma, and electrically connected at both ends thereof to a cathode of the rectifier (1210) and the first terminal, part (1311), respectively.

Preferably, the high-temperature heat generation device may further include a second reactor (1430) disposed on an input end of the series field part (1500) and configured to cause another arc discharge having magnetism.

Preferably, the first reactor for causing are discharge having magnetism may be a wire wound in a coil shape, and is configured to cause an end portion of a finally wound wire to be inserted into a central space defined by the coil-shaped wire, the finally wound wire being inserted into the central space in a direction from a start portion of the coil-shaped wire to an end portion of the coil-shaped wire.

Preferably, the first reactor for causing arc discharge having magnetism may be configured to be wound again around the wire, wound in the coil shape, in a doughnut-shape.

Preferably, the first reactor for causing arc discharge having magnetism may be configured to be wound in a coil shape, wherein each wire is wound from outside to inside of the wire so that the wire is twisted.

Preferably, the second and first terminal parts (1311, 1321) may be installed in ceramic tubes (1312 and 1322), respectively.

Preferably, the high-temperature heat generation device may be an incinerator, a boiler or a steam turbine.

In accordance with a second aspect of the present invention to accomplish the above objects, there is provided a sunlight color arc generation device, including a winding part (20) connected to alternating current (AC) power or DC power supply unit, and configured to maximize an AC inductive reactance and minimize a DC resistance; and an arc generation unit (30) connected to a first end of the winding part, wherein the winding part (20) includes a figure-of-eight coil part (200), and a coupling doughnut-shaped coil part (300) configured to penetrate through left and right ring-shaped loops (201 and 202) of the figure-of-eight coil part (200), wherein each of the figure-of-eight coil part (200) and the coupling doughnut-shaped coil part (300) includes at least one bundle of twisted wires, each twisted wire bundle is formed by twisting at least seven twisted wires, and each twisted wire includes at least one electric wire, so that the winding part (20) forms as many toroidal and poloidal magnetic fields as possible by using as short wires as possible, thus maximizing an AC inductive reactance and minimizing a DC resistance.

Preferably, the sunlight color arc generation device may further include a rectification circuit unit (10) for converting AC power into DC power, wherein a first end of the winding part (20) is connected to a first end of the rectification circuit unit (10), and wherein an electromagnet (40) is disposed between a second end of the winding part (20) and a second end of the rectification circuit unit (10).

Preferably, the winding part (20) may further include a single doughnut-shaped coil part (100).

Preferably, each of the coil parts may include a plurality of bundles of twisted wires, the twisted wire bundles being twisted in an identical direction.

Preferably, each of the twisted wires may be configured such that a plurality of electric wires connected in parallel to the rectification circuit unit are twisted in an identical direction.

Preferably, each of the electric wires may be configured such that one or more iron wires and copper wires are twisted in an identical direction in a single coating.

In accordance with a third aspect of the present invention to accomplish the above objects, there is provided a sunlight color high-pressure discharge lamp, driven by the sunlight color arc generation device, wherein electricity supply terminals of the high-pressure discharge lamp, instead of electrodes of the arc generation unit (30), are connected at locations of the electrodes.

### Advantageous Effects

A high-temperature heat generation device using an arc discharge reactor according to the present invention can obtain the following advantages.

First, since a spiral current can be generated using a simple configuration, the number of rotations depending on the spiral current is increased, thus obtaining better heat generation effects.

Second, since the rotation velocity of plasma can be raised to a high angular velocity using a magnetic force and high temperature can be obtained, any type of material can be burned, thus enabling the present invention to be utilized as a high-temperature heat generation device.

Third, it may be expected that application to an arc discharge lamp enables an arc discharge lamp exhibiting white light with a continuous spectrum to be implemented.

Fourth, the present invention has the advantage of energy efficiency because high-temperature heat having high luminance can be obtained with small input.

Further, in accordance with the sunlight color arc generation device according to the present invention, there is an advantage in that the device for forming an arc that contains hardly any harmful high frequencies and that contains most frequencies in the visible light can be provided.

The present sunlight color arc reactor emits light having sunlight color, so that the color of light having hardly harmful light causing industrial injuries to the bodies of welders is emitted, thus reducing physical damage, and minimizing damage caused by harmful light even in the case of a high-pressure discharge lamp such as a mercury discharge lamp.

### DESCRIPTION OF DRAWINGS

FIG. 1 is a diagram schematically showing the configuration of a Direct Current (DC) series motor related to a high-temperature heat generation device according to the present invention;

FIG. 2 is a diagram schematically showing the configuration of a high-temperature heat generation device using a DC series motor-type arc discharge reactor according to an embodiment of the high-temperature heat generation device of the present invention;

FIG. 3 is a perspective diagram showing a first modification of a reactor for causing arc discharge having magnetism according to the high-temperature heat generation device of the present invention;

FIG. 4 is a perspective view showing a second modification of a reactor for causing arc discharge having magnetism according to the high-temperature heat generation device of the present invention;

FIG. 5 is a diagram showing a picture of verification experiment of a high-temperature heat generation device using a reactor for causing arc discharge having magnetism according to the high-temperature heat generation device of the present invention;

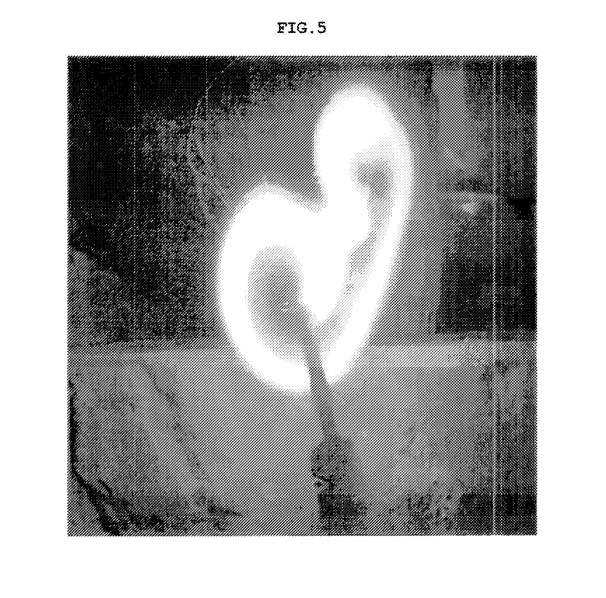

FIG. 6a is a diagram showing the principle of a tokamak related to a sunlight color arc generation device according to the present invention;

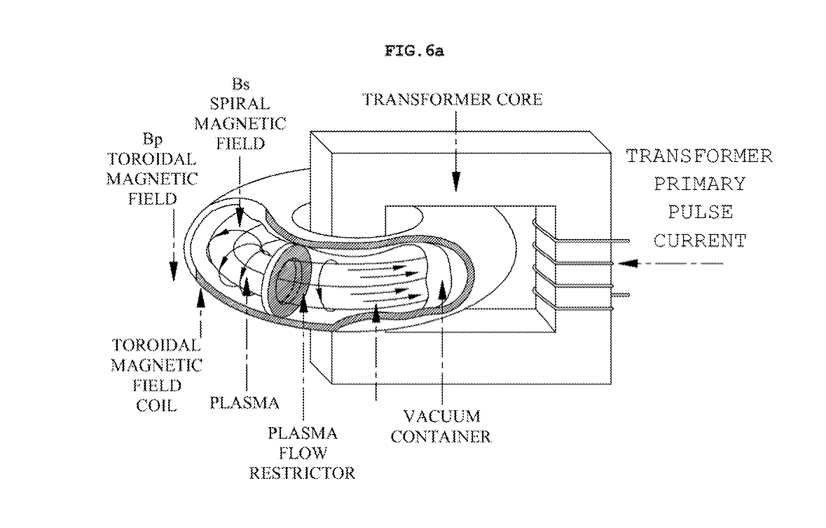

FIG. 6b is a diagram showing the principle of the formation of a toroidal magnetic field;

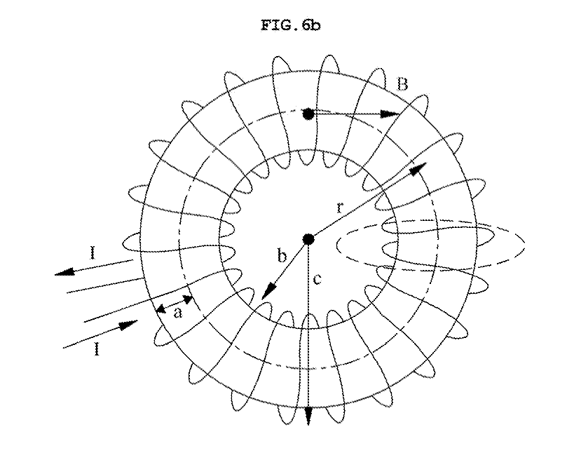

FIG. 6c is a diagram showing the motion of a charged particle in a parallel magnetic field;

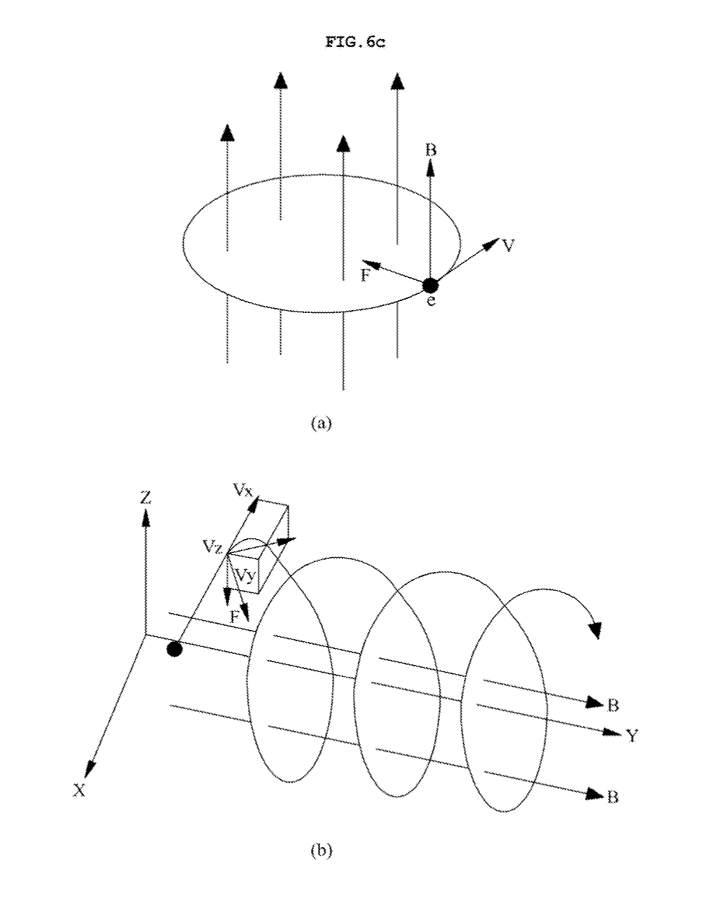

FIG. 6d is a diagram showing a form in which a plasma charged particle is spirally moving in a tokamak;

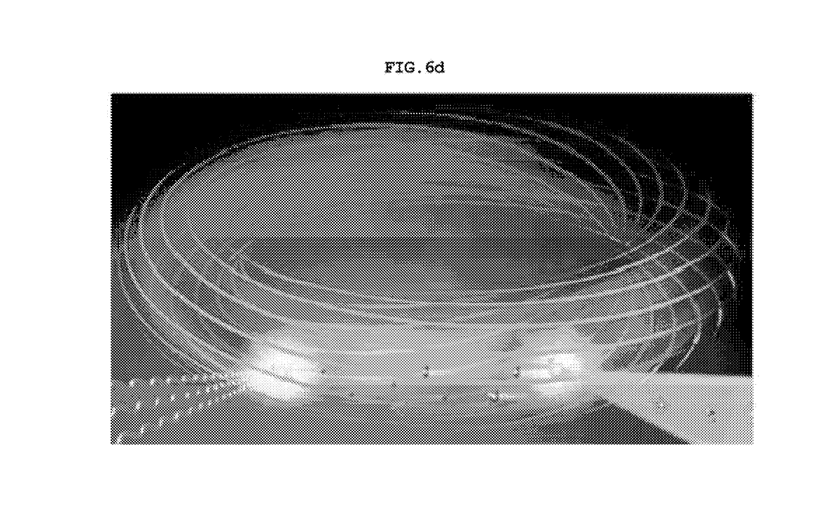

FIG. 7 is an entire circuit diagram showing a sunlight color arc generation device according to an embodiment of an arc generation device of the present invention;

FIG. 8a is a schematic model diagram showing the winding part of a sunlight color arc generation device according to an embodiment of the arc generation device of the present invention;

FIG. 8b is a schematic diagram showing a twisting method for the winding part of the sunlight color arc generation device according to an embodiment of the arc generation device of the present invention;

FIG. 9a illustrates an actual front picture of the winding part of the sunlight color arc generation device according to an embodiment of the arc generation device of the present invention;

FIG. 9b illustrates an actual picture, in which a figure-of-eight coil part and a doughnut-shaped coil part are unwound, in the winding part of the sunlight color arc generation device according to an embodiment of the arc generation device of the present invention;

FIG. 9c illustrates an actual plan picture of the winding part of the sunlight color arc generation device according to an embodiment of the arc generation device of the present invention;

FIG. 9d illustrates an actual detailed picture showing individual twisted wire bundles of the winding part of the sunlight color arc generation device according to an embodiment of the arc generation device of the present invention; and

FIG. 10 illustrates the results of analysis of a continuous spectrum of the sunlight color arc generation device according to an embodiment of the arc generation device of the present invention.

### BEST MODE

Hereinafter, preferred embodiments of the present invention will be described in detail with reference to the attached drawings. Prior to giving the description, the terms and words used in the present specification and claims should not be interpreted as being limited to their typical meaning based on the dictionary definitions thereof, but should be interpreted as having the meaning and concept relevant to the technical spirit of the present invention, on the basis of the principle by which the inventor can suitably define the implications of terms in the way which best describes the invention.

Accordingly, the embodiments described in the present specification and constructions shown in the drawings are only the most preferable embodiments of the present invention, and are not representative of the entire technical spirit of the present invention, and so it should be understood that various equivalents and modifications capable of replacing the embodiments and constructions of the present invention might be present at the time at which the present invention was filed.

First, a reactor for causing arc discharge having magnetism used in a high-temperature heat generation device according to the present invention is characterized in that a magnetic leakage iron core is not present, and current is magnetized without discarding a magnetic field, so that the collision energy of the magnetic field is added to arc discharge, thus improving efficiency.

A reactor used in the present invention is configured such that a conducting wire is wound in a doughnut shape. It is better to increase the number of turns, but if the number of turns is excessively large, resistance is also increased, and thus the reactor loses its own inherent property. A conducting wire wound in a circumferential direction is designated as a T (toroidal) coil 460. A conducting wire wound around the T coil in a direction perpendicular to that of the T coil is designated as a P (poloidal) coil 420. Such a reactor is characterized in that it has no iron core.

A typical ring-shaped reactor has a doughnut-shaped iron core and exhibits reactor properties only in AC power. However, the arc discharge reactor of the present invention exhibits reactor properties even in DC power in such a way as to store a magnetic field in the current of the P coil. The reason for this is that the current of the T coil generates a magnetic field in a poloidal (P) direction. The current of the P coil has the properties of a magnet, and NS collision energy of the magnetic field that is stored, as well as discharge energy that is electrical energy, is emitted if are discharge between a positive ion current output from the P coil and a negative ion current output from the T coil is caused.

Therefore, the discharge of the reactor used in the present invention is characterized in that a continuous spectrum is emitted unlike the line spectrum of typical arc discharge.

Further, the discharge of the reactor used in the present invention is characterized in that, if a magnet is placed close to the reactor, a counter electromotive force is caused, similar to the properties of a DC motor, and the rotation velocity is raised, and thus a strong continuous spectrum is emitted.

Light also causes luminescence attributable to a collision between an atom and an electron, as well as black-body (temperature) radiation by which brightness is increased in proportion to energy. Therefore, it is desired to definitely ensure that the discharge of the present invention does not violate the law of energy conservation.

The reactor used in the present invention to accomplish the above object is a coreless reactor in which a P coil is perpendicularly wound several times around a T coil which is wound several times in a doughnut shape. The reactor used in the present invention is configured such that current flowing through the T coil forms a magnetic field in the P direction, and such that, when current flows again in the P direction, the current is influenced by the previous P direction magnetic field, thus generating a spiral current. When such a spiral current causes arc discharge, magnetic properties are exhibited via arc discharge. Unlike a typical arc, there is a characteristic in that emitted light includes much white light.

Further, if the magnet is approximated to the reactor, a counter electromotive force is generated using a principle similar to that of a DC motor, so that arc discharge having magnetism causes strong rotation, and high-temperature light is emitted due to such high-speed rotation. This is a characteristic called an ‘arc’ which exhibits high luminance.

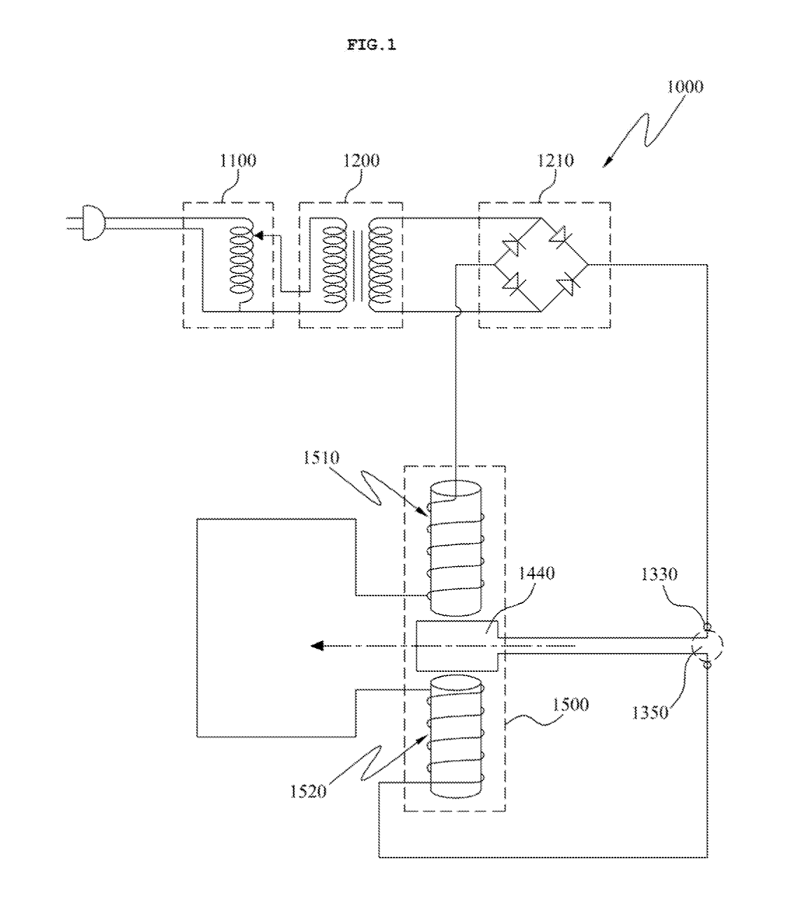

First, FIG. 1 is a diagram schematically showing the configuration of a DC series motor related to the present invention.

The configuration of a DC series motor 1000 includes a voltage controller 1100 configured to supply external power, a transformer 1200 provided with a rectifier 1210 so that AC power supplied from the voltage controller 1100 can be converted into DC power and the DC power can be supplied, a rotor 1440 configured to rotate an armature, a brush 1350 supplied with the DC power and configured to send the DC power to a commutator, and a series field part 1500 configured to form a magnetic field on the commutator 1330 for supplying current from the brush to the armature in a series motor-driven manner.

This configuration will be described in detail below for individual components.

The voltage controller 1100 is externally supplied with a voltage and supplies the voltage to the transformer 1200 as a constant voltage. Such a voltage controller 1100 is configured to control the magnitude of the voltage as well as the supply of a stabilized voltage, and is implemented using a voltage controller typically known as “Slidacs.”

The transformer 1200 is supplied with the external voltage via the primary side thereof from the voltage controller 1100. Further, the transformer 1200 steps up the external voltage, and outputs the stepped-up voltage to the secondary side thereof. In this case, the rectifier 1210 is connected to the secondary side of the transformer 1200 so that a DC voltage can be used.

The rectifier 1210 is electrically connected at its anode and cathode to the armature 1440 and the series field part 1500, respectively, which will be described later. This structure will be described in detail later upon describing the armature 1440 and the series field part 1500.

(Embodiment of High-Temperature Heat Generation Device)

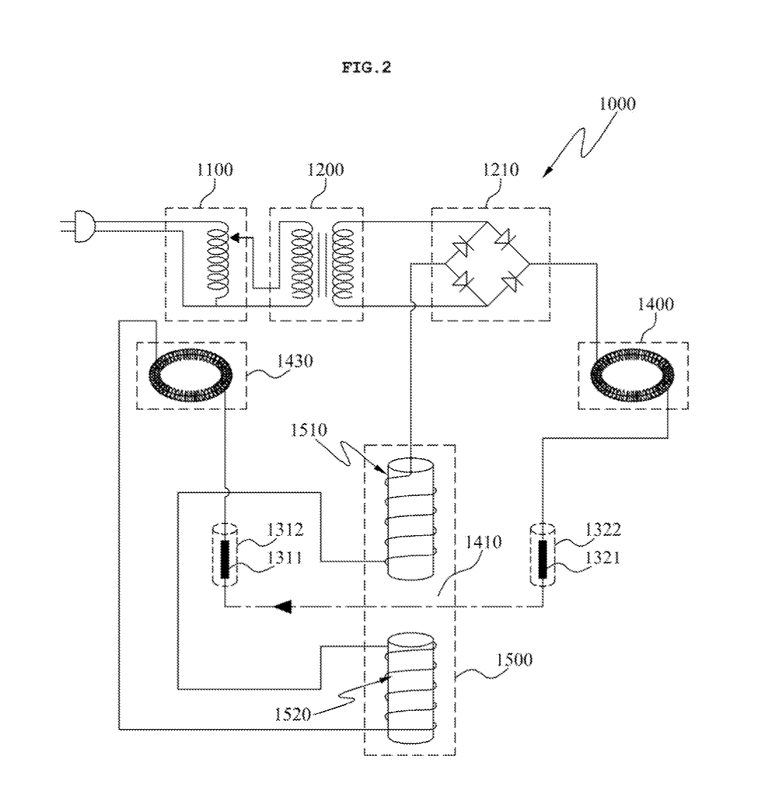

FIG. 2 is a diagram schematically showing a high-temperature heat generation device 1000′ using the reactor for causing arc discharge having magnetism according to a preferred embodiment of a high-temperature heat generation device of the present invention. Among the components, the same reference numerals are assigned to the same components as those in the conventional technology of FIG. 1, and a detailed description thereof will be omitted.

A high-temperature heat generation device 1000′ according to an embodiment of the present invention further includes a first reactor 1400 and/or a second reactor 1430 for causing arc discharge having magnetism in a series field part 1500. In this case, the reactors 1400 and 1430 for causing arc discharge having magnetism are installed to be disposed between a terminal part 1311 and the series field part 1500. That is, the first reactor 1400 for causing arc discharge having magnetism is connected at its input end to a rectifier 1210 and is electrically connected at its output end to a first terminal part 1321, and the second reactor 1430 is electrically connected at its input end to the second terminal part 1311 and at its output end to the series field part 1500.

Accordingly, the high-temperature heat generation device 1000′ of the present invention can generate a much stronger magnetic force on the series field part 1500 and can further increase the magnetic force of an induced current applied to an arc reactor 1410.

The arc reactor 1410 provides plasma that is not evaporated even at high temperature heat, and also functions as a heat insulating material for preventing the surroundings from being damaged due to high temperature. Further, a pair of second and first terminal parts 1311 and 1321 are provided in the arc reactor 1410 so that current flows through the medium of plasma.

Further, the respective terminal parts 1311 and 1321 are covered with materials enabling insulation and heat insulation, for example, ceramic tubes 1312 and 1322. The reason for this is to prevent burns or electric accidents from occurring as the terminal parts 1311 and 1321 come into contact with the arc reactor 1410. Furthermore, the ceramic tubes function to prevent current from leaking to the outside of the arc reactor 1410.

In the arc reactor 1410, as power is supplied to the individual terminal parts 1311 and 1321, an arc is formed at the terminal part 1311 of an output side thereof.

An arrow indicated in the arc reactor 1410 denotes the flow of plasma generated in the arc reactor 1410 as the power is supplied to the respective terminal parts 1311 and 1321.

The reactors 1400 and 1430 for causing arc discharge having magnetism are configured to generate rotating (spiral) current, and are each produced by winding an electric wire in the shape of a coil. As the electric wire used at this time, a typical electric wire may be used, but it is preferable to use an electric wire made of vinyl insulated nickel or a paramagnetic material so as to improve insulation and heat insulation effects and magnetization effects. Currently, since such a material is not produced, a vinyl insulated iron wire is used.

Each of the reactors 1400 and 1430 for causing arc discharge having magnetism is produced such that, in the state in which the wire is wound in the shape of a coil, the end of the coil is perpendicularly wound again in a doughnut shape so as to increase the intensity of a rotating (spiral) current. That is, each of the reactors 400 and 430 for causing arc discharge having magnetism is produced in such a way that an electric wire is wound in the shape of a coil-shaped large ring, and the end of the wire is perpendicularly wound again around the ring in the shape of a coil-shaped small ring.

The first reactor 1400 for causing arc discharge having magnetism, produced in this way, is configured such that the input end thereof is connected to the anode of the rectifier 1210 and the output end thereof is connected to the first terminal part 1321, and the second reactor 1430 is configured such that the output end thereof is connected to the series field part 1500 and the input end thereof is connected to the second terminal part 1311.

The series field part 1500 is a kind of field system having first and second field poles 1510 and 1520, and the first and second field poles 1510 and 1520 are installed to face each other with respect to the arc reactor 1410 and are wound in series. Further, the first field pole 1510 is electrically connected to the cathode of the rectifier 1210, and the second field pole 1520 is electrically connected to the terminal part 1311.

In this way, in the high-temperature heat generation device 1000′ according to an embodiment of the present invention, the voltage supplied through the voltage controller 1100 is stepped up by the transformer 1200 and then the stepped-up voltage is converted into a DC voltage, as described above. In particular, this DC voltage is supplied to the arc reactor 1410 in the form of a spiral current (rotating current) through the reactors 1400 and 1430 for causing arc discharge having magnetism, and the spiral current is used by the series field part 1500 to form a magnetic field through the medium of plasma.

Therefore, since current flowing through the arc reactor 1410 corresponds to an armature current (current flowing through a coil) of the DC series motor, and the terminal part 1311 and the series field part 1500 of the arc reactor 1410 are connected in series with each other, the high-temperature heat generation device 1000′ of the present invention has a structure connected in a DC series motor-driven manner.

In particular, the high-temperature heat generation device 1000′ of the present invention changes its state to a stage corresponding to “a large number of rotations” of arc discharge having magnetism. This principle is caused by a counter electromotive force and, in the case of typical motors, the number of rotations of each motor becomes the rated speed unless a load is connected. However, it is known that the rated speed of the DC series motor is increased up to a runaway speed, and then the motor is broken down in a no load condition.

The principle thereof will be described in brief. An AC motor in a no load condition generates a counter electromotive force for the frequency of input power and rotates only a number of times identical to a frequency speed, and a DC motor alternately switches over between a brush and a commutator and then generates a counter electromotive force in a direction opposite to that of a magnetic field that is input to the armature due to the inertia of current. The input power reaches a state in which it is barely present in no-load condition. However, if the motor cannot be rotated, the counter electromotive force has disappeared, and much current flows through the motor, so that the motor is overheated and thus the insulation coating of the motor is burned. Due to the properties of the DC series motor, an input current in a no load condition is decreased compared to an initial current, and power is stabilized. That is, it is known that if a DC series motor operating in a no-load condition at the rated voltage enters the state of a runaway speed, and the rotation of the armature is infinitely increased, rotation becomes unstable, wherein the input power at this time is decreased and the power becomes stable. In practice, the size of an atom is [m] unit, and the intensity of torque is also [nm] unit, so that the space of the atom has little frictional force. Therefore, the non-presence of a frictional resistance upon rotating means that the state of runaway speed has been reached.

<First Modification of Reactor for Causing Arc Discharge Having Magnetism>

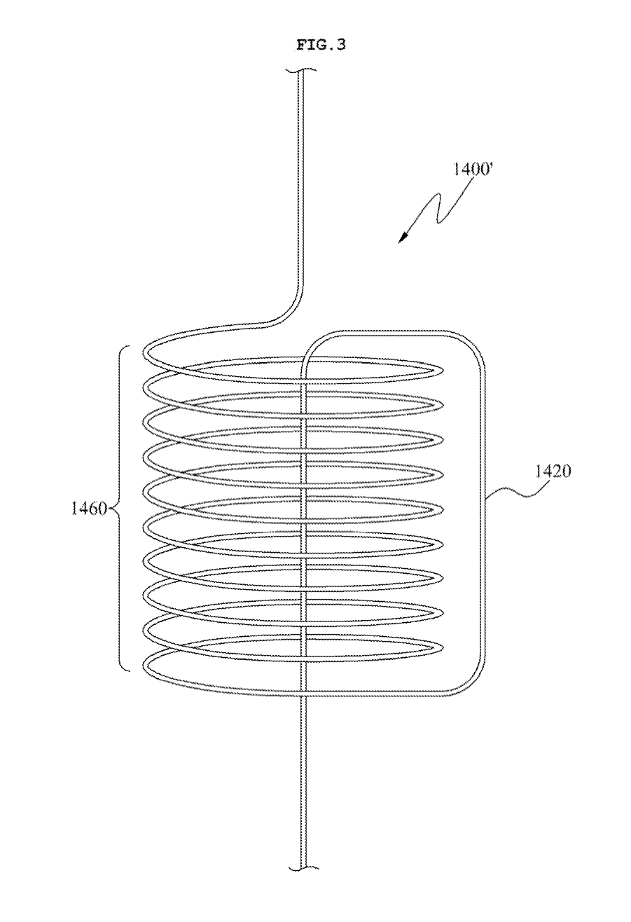

FIG. 3 is a perspective view showing a first modification of a reactor for causing arc discharge having magnetism according to the present invention.

A reactor 1400′ for causing arc discharge having magnetism according to a first modification of the present invention is formed to be wound in a coil shape. In this case, the end portion of a wire wound in the coil shape extends to the start portion of the reactor 1400′ for causing arc discharge having magnetism, and is inserted into a central space defined by the coil-shaped wire.

This structure will be described in detail below. The reactor 1400′ for causing arc discharge having magnetism includes a magnetic field winding part 1460 wound in the shape of a spring, and an electric field winding part 1420 perpendicularly wound around the magnetic field winding part 1460. In particular, the electric field winding part 1420 starts from the end portion of the magnetic field winding part 1460, extends to the start portion of the winding part 1460, and is wound around the winding part 1460 to be inserted into a central space defined by the winding part 1460 while wrapping the winding part 1460, as shown in FIG. 3. In this case, the electric field winding part 1420 is inserted into the central space from the start portion at which the magnetic field winding part 1460 is wound first.

Meanwhile, in FIG. 3, a configuration in which the electric field winding part 1420 is wound once is shown, but this is merely presented for convenience of description, and the electric field winding part 1420 can be wound even several times to several tens of thousand times.

<Second Modification of Reactor for Causing Arc Discharge Having Magnetism>

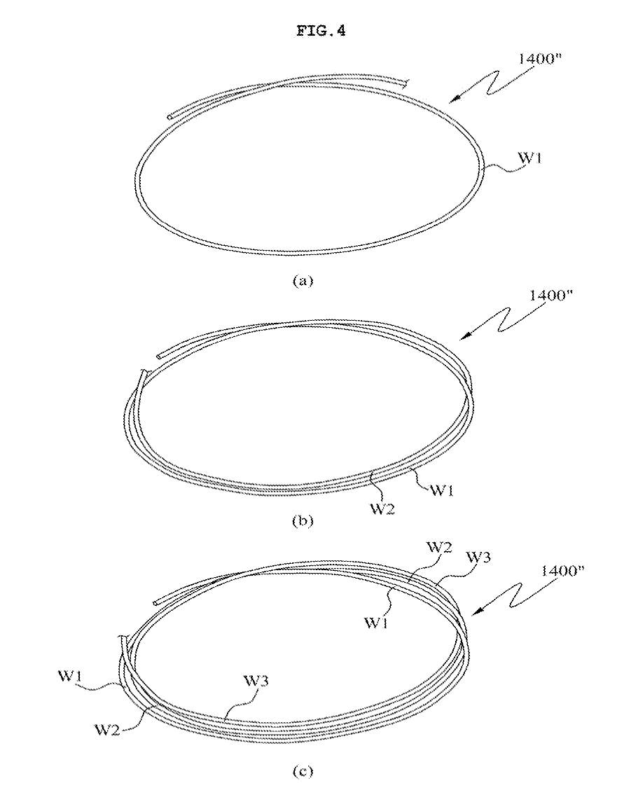

FIG. 4 is a perspective view showing a second modification of a reactor 1400″ for causing arc discharge having magnetism according to the present invention.

A reactor 1400′ for causing arc discharge having magnetism according to a second modification of the present invention is produced by twisting individual wires. That is, the reactor 1400″ which is a spiral current generator is configured such that, as shown in FIG. 4(a), a first wire W1 is wound in the shape of a coil. Further, a second wire W2 is wound to be inserted from the outside of the first wire W1 into the inside of the first wire W1, as shown in FIG. 4(b). In this case, the half of the second wire W2 is located outside of the first wire W1 and the remaining half of the second wire W2 is located inside of the first wire W1. Further, as shown in FIG. 4(c), half of a third wire W3 is located outside of the second wire W2 and the remaining half of the third wire W3 is located inside of the second wire W2. Accordingly, the half of the first wire W1 is located outside of both the second wire W2 and the third wire W3, and the half of the third wire W3 is located outside of both the first wire W1 and the second wire W2. In this case, the wire that is wound subsequently is moved in a winding direction by a distance corresponding to, for example, the diameter of the wire. That is, respective wires are wound so that the second wire W2 starts ahead of the crossing portion of the first wire W1, and the third wire W3 starts ahead of the crossing portion of the second wire W2.

As the reactor 1400″ for causing arc discharge having magnetism, wound in this way, is produced in a twisted shape in which, as winding is repeated using a method shown in FIG. 4, each wire is twisted once for the diameter of a virtual coil defined by the individual wires. Further, since the diameter of the virtual coil is gradually decreased because individual wires are repeatedly wound to be inserted from the outside into the inside. Consequently, when an n-th wire is wound, the reactor 1400′ for causing arc discharge having magnetism may be implemented such that the n-th wire is wound to be located on the central axis of the coil shape.

In FIG. 2, an arrow indicated along the horizontal axis of the series field part 1500 denotes the flow direction of plasma, and the flow of arc plasma that is phase-transformed by flame reaction is indicated together.

Those skilled in the art will easily understand that a high-temperature heat generation device 1000′ according to a modification of the second embodiment is connected in a DC series motor driven manner, similarly to the first embodiment.

(Embodiments of Sunlight Color Arc Generation Device)

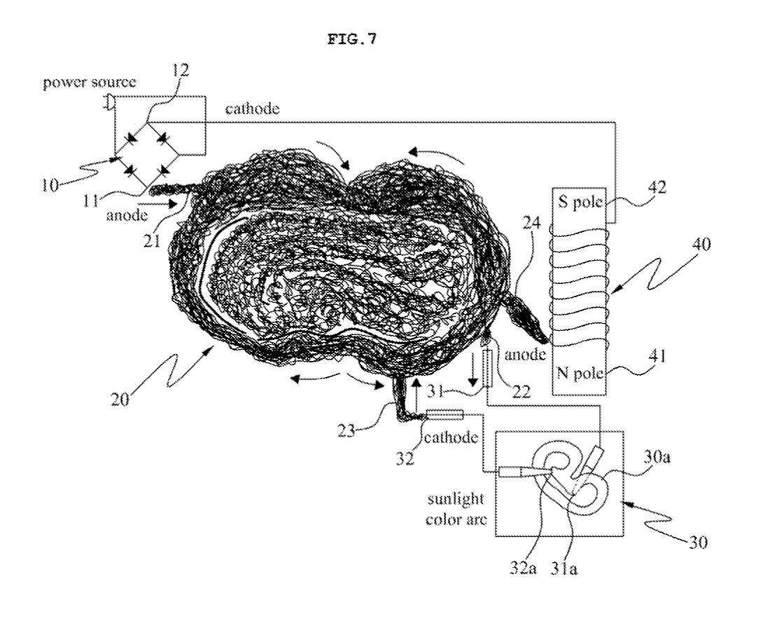

Meanwhile, a sunlight color arc generation device which is another aspect of the present invention will be described in detail with reference to FIGS. 7 to 10.

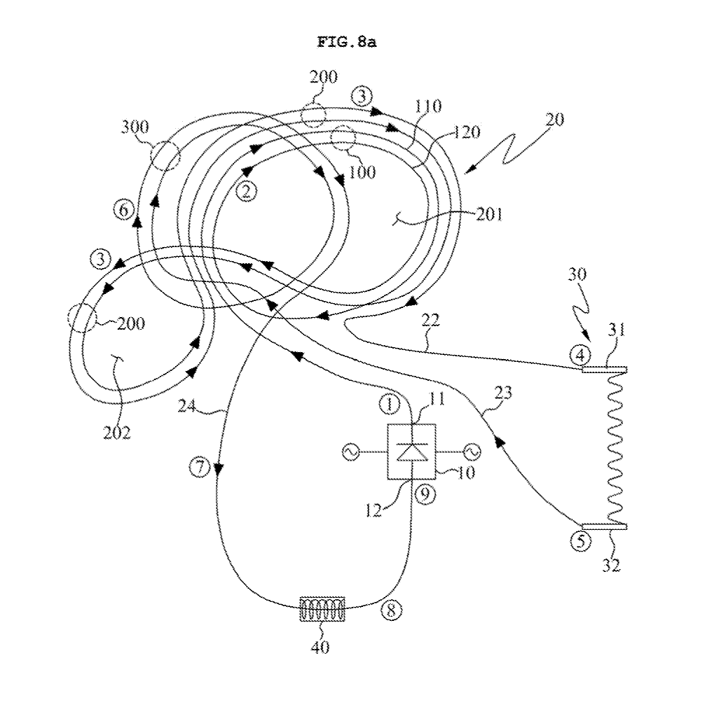

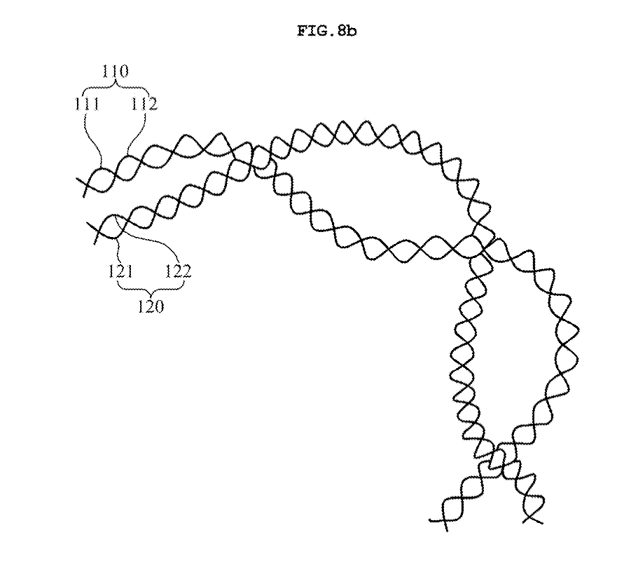

FIG. 7 is an entire circuit diagram showing a sunlight color arc generation device according to an embodiment of the present invention, FIG. 8a is a schematic model diagram showing the winding part thereof, and FIG. 8b is a schematic diagram showing a twisting method for the winding part.

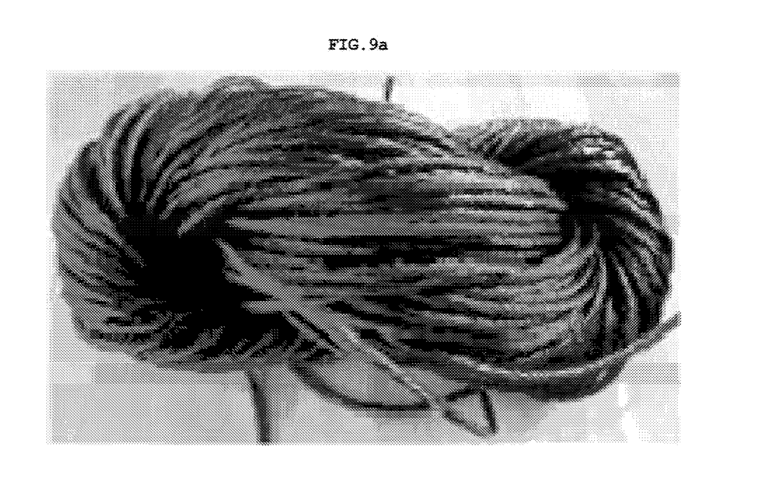

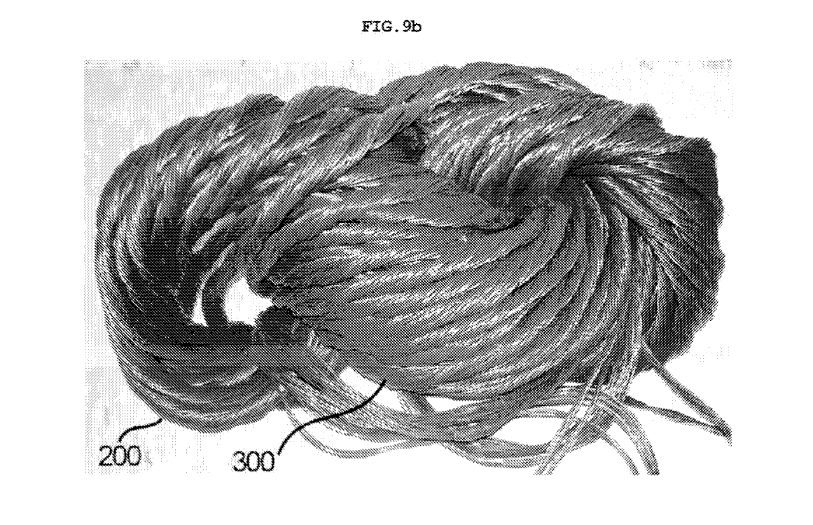

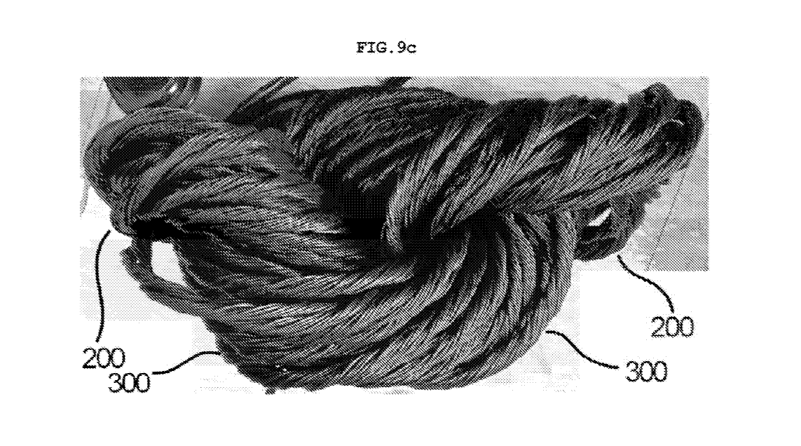

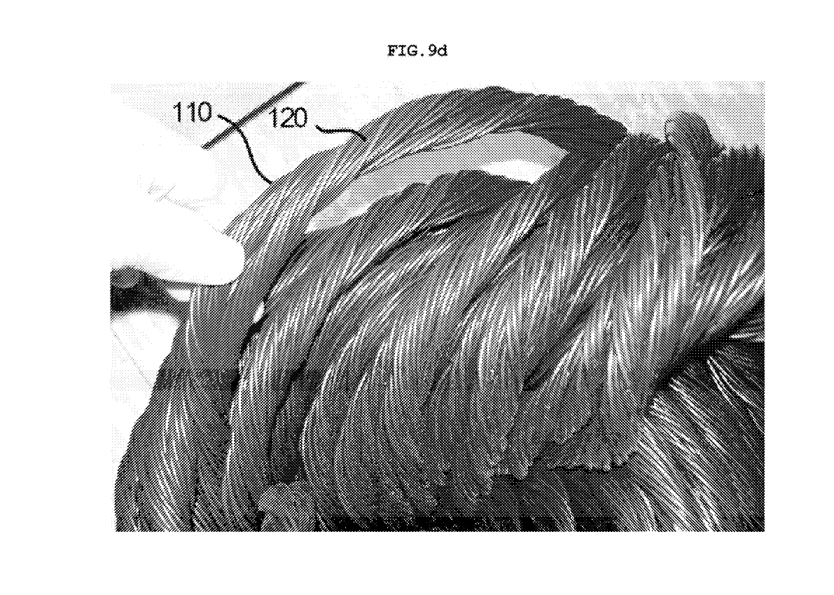

FIGS. 9a to 9d are diagrams showing an actual front picture of the winding part of the sunlight color are generation device according to an embodiment of the present invention, an actual picture in which a figure-of-eight coil part and a doughnut-shaped coil part are unwound in the winding part, an actual plan picture of the winding part, and an actual detailed picture showing individual twisted wire bundles of the winding part, respectively.

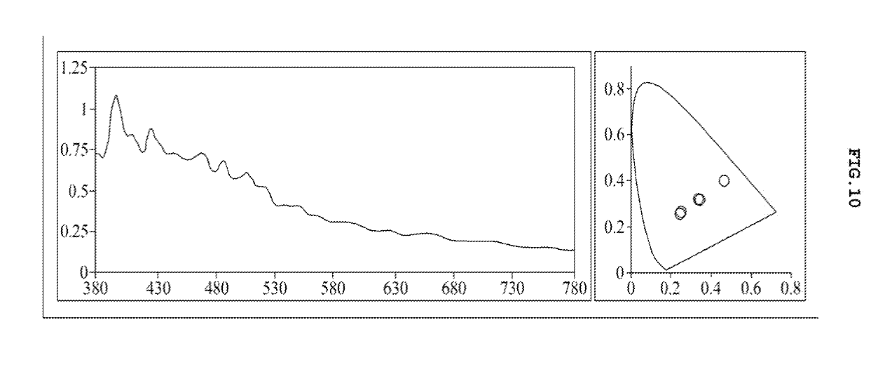

FIG. 10 illustrates the results of analysis of a continuous spectrum of a sunlight color arc generation device according to an embodiment of the present invention.

First, with reference to FIGS. 7 to 8b, the entire circuit diagram of a sunlight color arc generation device according to another embodiment of the present invention will be described.

First, with reference to FIGS. 7 and 8a, the arc generation device of the present invention is configured such that a winding part 20 unique to the present invention connected to a rectification circuit such as a bridge diode 10, which is connected to a commercial 220V AC power source and converts AC power to DC power, supplies a magnetized current to an arc generation unit 30 in a specific form (first embodiment).

As another embodiment, an electromagnet 40 may be inserted and connected to one end terminal of the bridge diode.

The winding part 20, as a first embodiment, basically includes a figure-of-eight coil part 200 and a coupling doughnut-shaped coil part 300 penetrating through the left and right ring-shaped loops 201 and 202 of the figure-of-eight coil part (the present embodiment corresponding to the first and second embodiments), and a single doughnut-shaped coil part 100 having the shape of a single loop identical to that of one side ring-shaped loop 201 or 202 of the figure-of-eight coil part may be further added to the above structure (a first modification of the first and second embodiments).

Then, the first end 21 of the winding part 20 is connected to anode (+) 11 of a bridge diode 10, and is connected to the anode (+) 31 of the arc generation unit 30 via the second end 22 of the winding part 20, either after passing through the figure-of-eight coil part 200 in the present embodiment of the first and second embodiments or passing through the single doughnut-shaped coil part 100 and the figure-of-eight coil part 200 in the first modification of the first and second embodiments.

Meanwhile, the cathode (−) 32 of the arc generation unit 30 is connected to the third end 23 of the winding part 20, and is connected to the cathode 12 of the bridge diode 10 via the fourth end 24 of the winding part 20 after passing through the coupling doughnut-shaped coil part 300 in a first embodiment, and is connected to the cathode 12 of the bridge diode 10 via the N pole 41 and the S pole 42 of the electromagnet 40 in the second embodiment. Reference numerals 31a and 32a, not described, denote the electrode needles of an anode (+) and a cathode (−), respectively, and reference numeral 30a denotes the shape of an arc when the arc, which moves in a direction from one electrode needle to the other electrode needle, goes round the electromagnet 40 due to the electromagnet 40.

Numerals indicated in circles in FIG. 8a represent the sequence of a current flow by numerals ranging from \textcircled{1} to \textcircled{1} in the first modification of the second embodiment which is an optimal embodiment.

The individual coil parts 100, 200, and 300 will be described in greater detail with reference to FIG. 8b. As shown in FIG. 8b, each coil part is composed of one or more bundles of twisted wires. For example, the single doughnut-shaped coil part 100 is implemented as at least one twisted wire bundle 110 or 120. In the case of FIG. 8b, the coil part is composed of two twisted wire bundles 110 and 120. When the coil part is composed of two or more twisted wire bundles, the individual twisted wire bundles 110 and 120 are configured to be mutually twisted in the same direction, as shown in FIG. 8b.

Furthermore, each twisted wire bundle 110 or 120 is composed of at least seven twisted wires. For example, the single doughnut-shaped coil part 100 is composed of two twisted wire bundles, the first twisted wire bundle 110 is composed of a first twisted wire 111 and a second twisted wire 112, and the second twisted wire bundle 120 is composed of at least a first twisted wire 121 and a second twisted wire 122. The twisting directions of individual twisted wires are also identical to those of the twisted wire bundles.

Furthermore, each twisted wire is composed of one or more electric wires, and may be composed of two or more electric wires connected in parallel depending on circumstances. In this case, individual electric wires are connected in parallel to the terminals of the bridge diode. It is preferable to connect as many electric wires as possible in parallel because a large amount of current is increased under the same condition, but, when an excessively large number of electric wires are connected in parallel, twisting is not desirably conducted, and it is difficult to connect parallel circuits, and thus it is preferable to allow four or eight electric wires to form a single twisted wire (in this case, the total current is, for example, 10˜50A). In this case, individual electric wires are preferably twisted in the same direction.

In addition, each electric wire is preferably implemented as a so-called polypropylene (PP) wire in which one or more copper wires and one or more iron wires are covered with a coating cable. The reason for this is that, as described above in the conventional technology, another induced electromotive force is generated while a magnetic force produced by the twisting of the copper wires and the ring-shaped structure is induced along the iron wires, and the magnetic force and the induced electromotive force interact with each other, thus producing a further improved electromotive force.

Therefore, a poloidal magnetic field is formed by the twisting of electric wires, twisted wires, and twisted wire bundles, a toroidal magnetic field is formed by the structure of the figure-of-eight-shaped or the doughnut-shaped coil part, and then the magnetic fields interact with each other.

Furthermore, the twisting of twisted wires may preferably be performed such that a wire of about 3 cm sufficient to form a toroidal magnetic field is consumed for twisting of a 1 pitch. In order to obtain maximum effect at a minimum length of electric wires upon causing interaction between the figure-of-eight-shaped or doughnut-shaped coil part and the twisted wires while forming a toroidal magnetic field using the structure of the coil part, it is preferable to generate as many ring-shaped structures as possible while shortening the length of electric wires.

FIGS. 9a to 9d illustrate pictures of an actual winding part according to the most preferable embodiment. As shown in FIG. 8b, in the optimal embodiment, eight electric wires (each electric wire is implemented as a PP wire in which three copper wires and four iron wires are covered with a single covering) form a single twisted wire, and four twisted wires form a single twisted wire bundle 110 while being twisted again (that is, while 32 electric wires are twisted as a single cable), and then 20 or 30 twisted wire bundles form each coil part while being twisted again. Then, even if the longitudinal length of the winding part is only about 80 cm, the length of a twisted wire (each electric wire) is about 200 m, so that twisting occurs about 20000 cm/3 cm≈6667 times for each electric wire, and a large number of toroidal and poloidal coils are formed while the twisted wires interact with each other.

In this way, as many toroidal and poloidal magnetic fields as possible are formed using electric wires having as short length as possible in this way, so that output forms an electric field and a magnetic field having a special shape, and output for minimizing an AC inductive reactance and a DC resistance can be obtained. Even upon generating an arc using those outputs, a sunlight color arc which is artificial light closest to sunlight capable of obtaining almost the same output in the entire visible light band, can be generated, as shown in FIG. 10.

For reference, the principles of a toroidal coil and a poloidal coil will be described below. In FIGS. 7 to 9d, the toroidal coil and the poloidal coil are devices for magnetizing electrons.

When a principle in which a magnetic field \vec{B} is magnetized into a charged particle magnetic field \vec{B_{T}} is mathematically described below, \vec{B} is assumed to be a toroidal magnetic field, which is formed using a poloidal current \vec{Iₚ} by the following Equation:

\vec{B}=μNₚ\vec{Iₚ}/2πr Equation 2

(Nₚ=number of turns, r=radius of rotation of poloidal current \vec{Iₚ})

The toroidal magnetic field adds the inherent current of a toroidal component and a spin current to current flowing through a conducting wire in a toroidal direction, and this is represented by the following Equation:

\vec{I}=\vec{I_{T}}+\vec{I_{P1}}Equation 3

(\vec{I_{P1}}:spin current, \vec{I_{T}}:inherent current of toroidal component)

Meanwhile, the spin current is represented by the following Equation:

$$\begin{matrix}{I}_{P 1} = \frac{{V}_{P}}{R} ( {Ohm}^{′} s law ) \\ = \frac{1}{R} {∮}_{C} {{E}_{P}}^{} \cdot {d {l}_{P}}^{} ( electric field and voltage ) \\ = \frac{1}{R} {\int }_{S} ( {∇}^{} \times {{E}_{P}}^{} ) \cdot {d {a}_{T}}^{} ( {Stokes}^{′} theorem ) \\ = - \frac{1}{R} {\int }_{S} \frac{d {B}^{}}{d t} \cdot {d {a}_{T}}^{} ( {Maxwell}^{′} s law ) \\ = - \frac{1}{R} {\int }_{S} \frac{{{I}_{r}}^{}}{e} \cdot {B}^{} d a ( Current , charge , and time relationship ) \\ = - \frac{1}{Re} {{I}_{T}}^{} \cdot {{Φ}_{T}}^{}\end{matrix} \qquad Equation 4$$

By means of the above Equation 4, when the toroidal current \vec{I_{T}} and the toroidal magnetic flux \vec{Φ_{T}} meet each other, they have the same direction and then they do not interact with each other, but the spin current \vec{I_{P1}} is formed.

Further, current may be magnetized by the following Equation 5:

\vec{B_{T}}=μNₚ\vec{I_{P1}}/2πr Equation 5

That is, the magnetic field \vec{B} becomes the charged particle magnetic field \vec{B_{T}}. This means that if toroidal and poloidal coils are desirably wound, the current is sufficiently magnetized, so that the spin current \vec{I_{P1}} is formed, and a spin electron in an atom has the following energy and force:

energy W_{M}=e\vec{r}·(\vec{vₚ}×\vec{B_{T}}) and

force \vec{F_{M}}=e(\vec{vₚ}×\vec{B_{T}}) Equation 6

The attraction of a magnet is directly added.

Such a phenomenon is described as “subjected to a Lorentz force” in a tokamak theory.

That is, Bs (spiral magnetic field)=Bp (poloidal magnetic field; rotational displacement)+Bt (toroidal magnetic field)

Meanwhile, an electron e has an electric field E and a magnetic field B as given by the following Equation:

$$e = \frac{W ( = energy )}{{r}^{->} \cdot ( {E}^{} + {v}^{} \times {B}^{} ) ( = voltage )} \qquad Equation 7$$

However, in order to artificially make the magnetic field \vec{B} be horizontal to the velocity direction \vec{v} (that is, the direction of the current \vec{I_{T}}), a device using a toroidal wire and a poloidal wire is configured.

Therefore, the direction of the magnetic field \vec{B_{T}} of the charged particle becomes identical to the velocity direction \vec{v}, and this phenomenon is generally called “magnetized”. The term “magnetization” denotes having the spin magnetic field \vec{B_{T}}.

When an external electron provides ionization energy to a free electron, a spin magnetic field is additionally transferred from the device using the toroidal wire and the poloidal wire, wherein the spin magnetic field \vec{B_{T}} also has the spin current \vec{I_{P1}}.

\vec{Bᵣ}=μNₚ\vec{I_{P1}}/2πr Equation 8

Meanwhile, in the case of a spin nucleus and a spin electron different from equations of quantum mechanics, the following Equation is satisfied in a Bohr model.

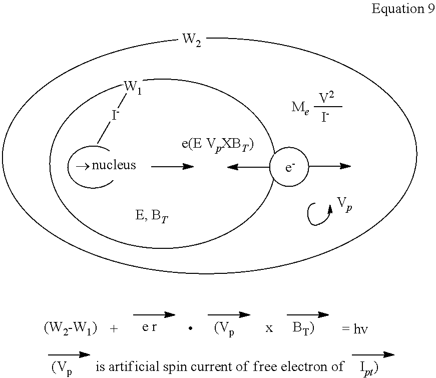

Generally, an electron is never magnetized. An electron has only quantum mechanical spin. However, when passing through the device of the present invention, an electron is strongly magnetized. The magnetized electron exhibits a force represented by the following Equation 10, and Equation 11 is obtained if the force is represented by the energy of the electron.

\vec{F_{M}}=e(\vec{vₚ}×\vec{B_{T}}) Equation 10

W_{M}=e\vec{r}·(\vec{vₚ}×\vec{B_{T}}) Equation 11

Therefore, hv is influenced by the intensity of W_{M}=e\vec{r}·(\vec{vₚ}×\vec{B_{T}}) and has a plurality of values, with the result that the wavelength of light (λ=c/v) is emitted with various values. Therefore, continuous wavelength sunlight colors, including infrared light, red, orange, yellow, green, cyan, blue, purple, and ultraviolet light, are emitted.

In practice, parts of the pieces of data obtained by generating an arc in the sunlight color arc reactor, measuring a spectrum using a spectroscope, and analyzing the measured results according to the present invention are shown in Tables 1 and 2.

TABLE 1

| Wavelength (nm) | Luminosity factor |
|---|---|
| 305 | 0.018786 |
| 306 | 0.029715 |
| 307 | 0.044013 |
| 308 | 0.054286 |
| 309 | 0.049106 |
| 310 | 0.049261 |
| 311 | 0.050075 |
| 312 | 0.051709 |
| 313 | 0.05563 |
| 314 | 0.061605 |
| 315 | 0.071103 |

Table 1 shows an ultraviolet region having a short wavelength, and Table 2 shows the results of measuring the maximum luminosity factor thereof.

FIG. 10 illustrates the results of spectrum analysis when an arc is generated using a sunlight color arc reactor device according to the present invention and the spectrum of the sunlight color arc is analyzed, wherein in FIG. 10, a fore left portion shows a graph in which a vertical axis indicates luminosity factors and a horizontal axis indicates wavelength (nm), and a rear right portion denotes a CIE color representation system.

TABLE 2

| Wavelength (nm) | Luminosity factor |
|---|---|
| 392 | 0.894724 |
| 393 | 0.951885 |
| 394 | 1.001691 |
| 395 | 1.040513 |
| 396 | 1.066239 |
| 397 | 1.077966 |
| 398 | 1.075133 |
| 399 | 1.057332 |
| 400 | 1.029759 |
| 401 | 0.994566 |

In the case of the intensity of the charged particle magnetic field \vec{B_{T}}, if the number of parallel wires in the toroidal and poloidal wires is increased, and the parallel wires are twisted in the same direction, resistance R is decreased, and the number of turns N is increased.

In this way, most energy of a maximal input voltage is converted into W_{M}=e\vec{r}·(\vec{vₚ}×\vec{B_{T}}). In this case, the forces of an atom nucleus, a static electron, and a free electron in an atom are represented by the following Equation 12 in a quantum mechanical Bohr model:

$${F}^{} = e {E}^{} + {m}_{e} \frac{{v}^{2}}{{r}^{->}} = 0 \qquad Equation 12$$

However, force F is given by the following Equation:

$${F}^{} = e {E}^{} + e ( {{v}_{P}}^{} \times {{B}_{T}}^{} ) + {m}_{e} \frac{{v}^{2}}{{r}^{->}} \neq 0 \qquad Equation 13$$

Therefore, the force \vec{F_{M}}==e(\vec{vₚ}×\vec{B_{T}}) of the electrons magnetized by Equation 10 is influenced by the attraction of the magnetic field, and when this force is maximized (vₚ=c(3×10⁸ m/s)), more energy may be emitted.

As described above, the approaches of the present invention are to modify a conventional tokamak device into a device for magnetizing electrons via DC mutual induction between a toroidal current and a poloidal current, which are DC currents using toroidal and poloidal coils, and generating a sunlight color arc using the force of a magnetic field and attraction, without quantum-mechanically sealing induced plasma using the force of the magnetic field of a conventional tokamak device.

In other words, the present invention is characterized in that most of the AC inductive reactance (experimental device is a DC device) and DC resistance (several electric wires are twisted and used) are eliminated.

Further, if the principle of a DC series motor which is operated using a counter electromotive force is applied to a circuit, output is strengthened while input is decreased, thus obtaining high energy.

Meanwhile, a sunlight color high-pressure discharge lamp according to a further aspect of the present invention will be described below.

The sunlight color high-pressure discharge lamp according to the present invention is driven by the sunlight color arc generation device, and positive (+) and negative (−) terminals for power supply of the high-pressure discharge lamp, instead of the anode (+) 31 and the cathode (−) 32 of the arc generation unit, are connected to the second and third terminals 22 and 23 of the winding part at the locations of the anode (+) 31 and the cathode (−) 32. Even in this case, there can be provided a high-pressure discharge lamp for emitting light almost the same as sunlight color from which almost uniform light intensity can be obtained in all visible light wavelength bands.

As described above, although the present invention has been described using several optimal embodiments, it is apparent that various modifications are possible, the scope of the present invention is limited only by the accompanying claims, and those skilled in the art can improve and modify the technical spirit of the present invention in various forms. Therefore, the additional improvements and modifications of the present invention will be included in the scope of the present invention as long as they are apparent to those skilled in the art.

1-14. (canceled)

15. A high-temperature heat generation device using an arc discharge reactor, comprising:
a voltage controller (1100) supplied with external power and configured to stably supply a voltage;
a transformer (1200) electrically connected on a primary side thereof to the voltage controller (1100) and on a secondary side thereof to a rectifier (1210);
an arc reactor (1410) configured to enable flow of plasma, and provided with a pair of second and first terminal parts (1311 and 1321) installed to be spaced apart from each other by a predetermined interval;
a first reactor (1400) connected at a first end thereof to an anode of the rectifier (1210) and at a second end thereof to the first terminal part (1321), and configured to cause are discharge having magnetism; and
a series field part (1500) arranged on opposite sides with respect to the arc reactor (1410) so that a magnetic field is formed in a direction perpendicular to a movement direction of plasma, and electrically connected at both ends thereof to a cathode of the rectifier (1210) and the first terminal part (1311), respectively.

16. The high-temperature heat generation device of claim 15, further comprising a second reactor (1430) disposed on an input end of the series field part (1500) and configured to cause another arc discharge having magnetism.

17. The high-temperature heat generation device of claim 15, wherein the first reactor for causing arc discharge having magnetism is a wire wound in a coil shape, and is configured to cause an end portion of a finally wound wire to be inserted into a central space defined by the coil-shaped wire, the finally wound wire being inserted into the central space in a direction from a start portion of the coil-shaped wire to an end portion of the coil-shaped wire.

18. The high-temperature heat generation device of claim 15, wherein the first reactor for causing arc discharge having magnetism is configured to be wound again around the wire, wound in the coil shape, in a doughnut-shape.

19. The high-temperature heat generation device of claim 15, wherein the first reactor for causing arc discharge having magnetism is configured to be wound in a coil shape, wherein each wire is wound from outside to inside of the wire so that the wire is twisted.

20. The high-temperature heat generation device of claim 15, wherein the second and first terminal parts (1311, 1321) are installed in ceramic tubes (1312 and 1322), respectively.

21. The high-temperature heat generation device of claim 15, wherein the high-temperature heat generation device is an incinerator, a boiler or a steam turbine.

22. The high-temperature heat generation device of claim 16, wherein the high-temperature heat generation device is an incinerator, a boiler or a steam turbine.

23. A sunlight color arc generation device, comprising:
a winding part (20) connected to alternating current (AC) power or DC power supply unit, and configured to maximize an AC inductive reactance and minimize a DC resistance; and
an arc generation unit (30) connected to a first end of the winding part,
wherein the winding part (20) comprises:
a figure-of-eight coil part (200), and
a coupling doughnut-shaped coil part (300) configured to penetrate through left and right ring-shaped loops (201 and 202) of the figure-of-eight coil part (200),
wherein each of the figure-of-eight coil part (200) and the coupling doughnut-shaped coil part (300) includes at least one bundle of twisted wires, each twisted wire bundle is formed by twisting at least seven twisted wires, and each twisted wire includes at least one electric wire, so that the winding part (20) forms as many toroidal and poloidal magnetic fields as possible by using as short wires as possible, thus maximizing an AC inductive reactance and minimizing a DC resistance.

24. The sunlight color arc generation device of claim 23, further comprising a rectification circuit unit (10) for converting AC power into DC power,
wherein a first end of the winding part (20) is connected to a first end of the rectification circuit unit (10), and
wherein an electromagnet (40) is disposed between a second end of the winding part (20) and a second end of the rectification circuit unit (10).

25. The sunlight color arc generation device of claim 23, wherein the winding part (20) further comprises a single doughnut-shaped coil part (100).

26. The sunlight color are generation device of claim 23, wherein each of the coil parts comprises a plurality of bundles of twisted wires, the twisted wire bundles being twisted in an identical direction.

27. The sunlight color arc generation device of claim 24, wherein each of the coil parts comprises a plurality of bundles of twisted wires, the twisted wire bundles being twisted in an identical direction.

28. The sunlight color arc generation device of claim 23, wherein each of the twisted wires is configured such that a plurality of electric wires connected in parallel to the rectification circuit unit are twisted in an identical direction.

29. The sunlight color arc generation device of claim 24, wherein each of the twisted wires is configured such that a plurality of electric wires connected in parallel to the rectification circuit unit are twisted in an identical direction.

30. The sunlight color are generation device of claim 23, wherein each of the electric wires is configured such that one or more iron wires and copper wires are twisted in an identical direction in a single coating.

31. The sunlight color are generation device of claim 24, wherein each of the electric wires is configured such that one or more iron wires and copper wires are twisted in an identical direction in a single coating.

32. A sunlight color high-pressure discharge lamp, driven by the sunlight color arc generation device of claim 23, wherein electricity supply terminals of the high-pressure discharge lamp, instead of electrodes of the arc generation unit (30), are connected at locations of the electrodes.

33. A sunlight color high-pressure discharge lamp, driven by the sunlight color arc generation device of claim 24, wherein electricity supply terminals of the high-pressure discharge lamp, instead of electrodes of the arc generation unit (30), are connected at locations of the electrodes.
